(19) United States
(12) Patent Application Publication
(10) Pub. No.: US 2023/0088625 A1
(43) Pub. Date: Mar. 23, 2023

(54) OPERATION METHOD OF BLOCKCHAIN REMITTANCE SERVICE SYSTEM, AND ELECTRONIC WALLET FOR REMITTANCE

(71) Applicant: SOVEREIGN WALLET CO., LTD., Seoul (KR)

(72) Inventor: Seok Gu YUN, Seoul (KR)

(73) Assignee: SOVEREIGN WALLET CO., LTD., Seoul (KR)

(21) Appl. No.: 17/798,758

(22) PCT Filed: Feb. 4, 2021
(86) PCT No.: PCT/KR2021/001478

§ 371 Date: Aug. 10, 2022

(30) Foreign Application Priority Data
Feb. 13, 2020 (KR) 10-2020-0017717

(51) Int. Cl. G06Q 20/36; G06Q 20/38

(52) U.S. Cl. CPC G06Q 20/363; G06Q 20/367; G06Q 20/3825; G06Q 20/3829; G06Q 2220/00

(57) ABSTRACT

Provided is an operation method of a blockchain remittance service system. The operation method includes storing, performed by a sender's electronic wallet, remittance information in a blockchain network, the sender's electronic wallet being executed on a sender computing device; and transmitting, performed by the sender's electronic wallet, sender information to an information transmission channel to allow a receiver's electronic wallet to acquire the sender information, the receiver's electronic wallet being executed on a receiver computing device.

### TECHNICAL FIELD

The present invention relates to a blockchain system, and more particularly, to an operation method of a blockchain remittance service system capable of transmitting and receiving remittance information, sender identity information, and receiver identity information and an electronic wallet for remittance.

### BACKGROUND ART

A blockchain is ledger management technology based on distributed computing, in which pieces of small data, called blocks, of managed object data are stored in a chain-type, link-based distributed data storage environment created based on a peer-to-peer (P2P) method so that no one can randomly modify the managed object data and any one can read a changed result.

A blockchain (or a blockchain system) includes an unforgeable and irreversible database system and a blockchain address created by a user through public-key cryptography.

Transaction information recorded in a blockchain includes remittance information transmitted from one blockchain address to another blockchain address. To ensure the anonymity of a transaction, a blockchain records only details of dealing between blockchain addresses including numbers, and information about the owner of each of the blockchain addresses is not recorded.

### DESCRIPTION OF EMBODIMENTS

### Technical Problem

Provided are an operation method of a blockchain remittance service system and an electronic wallet for remittance, by which sender identity information and receiver identity information may be transmitted and received through an information transmission channel (e.g., a state channel, a shared database, or an identity blockchain network), which is separate from a blockchain network (or a blockchain) that processes remittance information.

### Solution to Problem

According to an aspect of the present disclosure, an operation method of an operation method of a blockchain remittance service system includes storing, performed by a sender's electronic wallet, remittance information in a blockchain network, the sender's electronic wallet being executed on a sender computing device; and transmitting, performed by the sender's electronic wallet, sender information to an information transmission channel to allow a receiver's electronic wallet to acquire the sender information, the receiver's electronic wallet being executed on a receiver computing device.

According to another aspect of the present disclosure, an electronic wallet program stored in a medium, which processes remittance information, sender information, and receiver information in combination with hardware, is configured to store remittance information to be transmitted to a receiver's electronic wallet program in a blockchain network, transmit the sender information to be transmitted to the receiver's electronic wallet program to an information transmission channel, and receive the receiver information from the receiver's electronic wallet program through the information transmission channel.

According to still another aspect of the present disclosure, an electronic wallet program stored in a medium, which processes remittance information, sender information, and receiver information in combination with hardware, includes a first identity wallet storing the sender information in a first blockchain network, the sender information being transmitted to a second identity wallet of a receiver's electronic wallet program; and a first blockchain wallet storing the remittance information in a second blockchain network, the remittance information being transmitted to a second blockchain wallet of the receiver's electronic wallet program. The first identity wallet may be further transmitting the receiver information stored in the first blockchain network to the first blockchain wallet, and the first blockchain wallet may be further displaying the receiver information on a display device.

According to a further aspect of the present disclosure, an operation method of a blockchain remittance service system includes storing, performed by a first identity wallet, sender information in a first blockchain network, the first identity wallet being included in a sender's electronic wallet, and the sender information being transmitted to a second identity wallet of a receiver's electronic wallet; storing, performed by a first blockchain wallet, remittance information in a second blockchain network, the first blockchain wallet being included in the sender's electronic wallet, and the remittance information being transmitted to a second blockchain wallet of the receiver's electronic wallet; transmitting, performed by the first identity wallet, receiver information stored in the first blockchain network to the first blockchain wallet; and displaying, performed by the first blockchain wallet, the receiver information on a display of a sender computing device configured to execute the sender's electronic wallet.

### Advantageous Effects of Disclosure

According to an embodiment of the present disclosure, an operation method of a blockchain remittance service system and an electronic wallet for remittance may enable sender identity information and receiver identity information to be transmitted and received through an information transmission channel (e.g., a state channel, a shared database, or an identity blockchain network), which is separate from a blockchain network (or a blockchain) that processes remittance information.

When a token amount is remitted from a sender's electronic wallet to a receiver's electronic wallet through the blockchain network, the sender identity information and the receiver identity information is transmitted to each other's electronic wallets through the information transmission channel (e.g., a state channel, a shared database, or an identity blockchain network), which is separate from the blockchain network. Accordingly, the blockchain network may identify the sender identity information and the receiver identity information.

### BRIEF DESCRIPTION OF DRAWINGS

FIG. 1 is a block diagram of a blockchain remittance service system including a state channel, according to an embodiment of the present disclosure.

FIG. 2 is a block diagram of a blockchain remittance service system including a shared database, according to an embodiment of the present disclosure.

FIG. 3 is a diagram for describing an operation of each of identity wallets storing information in an identity blockchain network, according to an embodiment of the present disclosure.

FIG. 4 is a block diagram of a blockchain remittance service system including an identity blockchain network, according to an embodiment of the present disclosure.

### MODE OF DISCLOSURE

An electronic wallet or an e-wallet, which is known as a digital wallet, a smart wallet, a crypto wallet, or a blockchain wallet, refers to an electronic device or an online service, which allows an individual to conduct electronic transactions, e.g., token buying, selling, sending, and/or tracking. In the present disclosure, a blockchain wallet and an identity wallet refer to e-wallets (or e-wallet programs).

A sender's e-wallet (or a sender's e-wallet program) 115 refers to an application executed by a processor (or a central processing unit (CPU)) of a sender computing device 110, and a receiver's e-wallet (or a receiver's e-wallet program) 135 refers to an application executed by a processor (or a CPU) of a receiver computing device 130. At this time, an application refers to application software, a computer program, software, or an app but is not limited thereto.

Each of the sender computing device 110 and the receiver computing device 130 may refer to a personal computer (PC) or a mobile device, wherein each of the PC and the mobile device includes an input device (e.g., a keyboard or a touch pad), a processor, a memory device, and a display. The mobile device may include a laptop computer, a mobile Internet device (MID), a smartphone, or an Internet of things (IoT) device but is not limited thereto. An e-wallet is stored in a memory device of a computing device and executed by a processor.

Here, an e-wallet refers to an application performing a similar function to a banking app.

A sender address (or a sender blockchain address) SADD is generated by the sender's e-wallet 115 and used to identify a sender in a blockchain network 150 and is similar to the sender's bank account information.

A receiver address (or a receiver blockchain address) RADD is generated by the receiver's e-wallet 135 and used to identify a receiver in the blockchain network 150 and is similar to the receiver's bank account information.

User identification information (or user identity information) refers to personal information (e.g., a name, an address, and/or a date of birth), which is included in an identification card (or a copy thereof), a resident registration card (or a copy thereof), a passport (or a copy thereof), a driver's license (or a copy thereof), or the like of a user, and the user refers to a sender or a receiver. A token refers to electronic money, a digital currency, a cryptocurrency, or a virtual currency.

In the present disclosure, that a first e-wallet exchanges information with a second e-wallet means that a first computing device executing the first e-wallet exchanges the information with a second computing device executing the second e-wallet through a communication network.

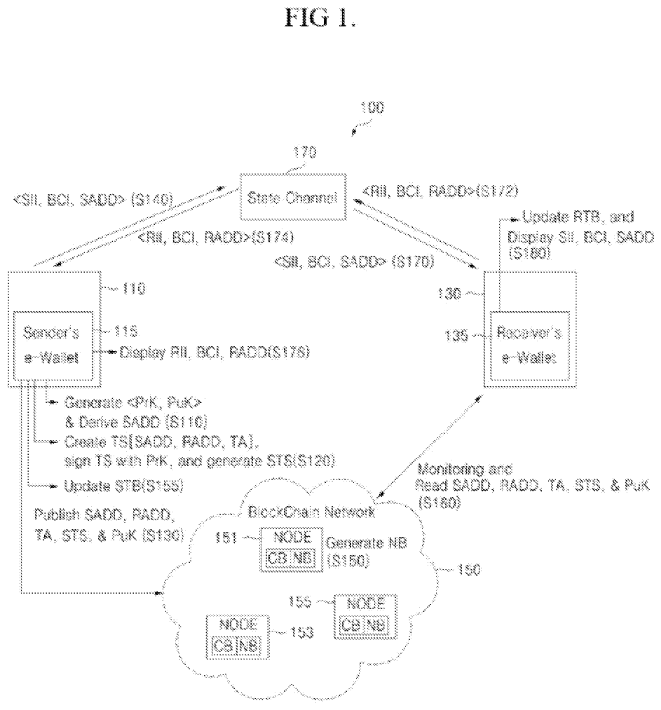

FIG. 1 is a block diagram of a blockchain remittance service system including a state channel, according to an embodiment of the present disclosure. Referring to FIG. 1, a blockchain remittance service system (e.g., a blockchain system or a distributed ledger processing system) 100 includes a sender computing device 110, a receiver computing device 130, a state channel 170, and a blockchain network 150.

The state channel 170 is an example of an information transmission channel (or an information transmission device) that may transmit information described below in operations S140, S170, S172, and S174.

The sender's e-wallet 115 of a sender generates a pair <PrK, PuK> of a private key PrK of the sender and a public key PuK of the sender and generates (or derives) a sender address SADD from the public key PuK (or by applying a hash function to the public key PuK) in operation S110.

When the sender inputs the receiver address RADD and a token amount TA corresponding to a remittance amount into the sender's e-wallet 115 by using the input device of the sender computing device 110, the sender's e-wallet 115 creates a transaction TS, which includes the sender address SADD, the receiver address RADD, and the token amount TA, and generates a digitally signed transaction STS by digitally signing the transaction TS with the private key PrK in operation S120. The sender's e-wallet 115 generates remittance information, which includes the sender address SADD, the receiver address RADD, the token amount TA, the digitally signed transaction STS, and the public key PuK, and publishes the remittance information on the blockchain network 150 in operation S130.

Here, the remittance information may be included in a blockchain ledger, which includes a plurality of blocks in a chain, and the token amount TA may refer to the amount of blockchain-based electronic money, digital currency, cryptocurrency, or virtual currency.

The sender's e-wallet 115 transmits sender identity information SII which is generated in operation S120 in relation with the transaction TS, blockchain information BCI, and the sender address SADD to the state channel 170 in operation S140.

According to embodiments, sender information may include the sender identity information SII and the sender address SADD. The sender information may further include the blockchain information BCI. Receiver information may include receiver identity information RII and the receiver address RADD. The receiver information may further include the blockchain information BCI.

Here, the blockchain information BCI is about the blockchain network 150. The blockchain information BCI is unique information, such as a blockchain network name, a blockchain identifier, and/or a smart contract address, which is used to identify the blockchain network 150 used for the remittance of the token amount TA.

The sender's e-wallet 115 and the receiver's e-wallet 135, which are described with reference to FIGS. 1 to 4, may exchange information (e.g., the sender identity information SII and the receiver identity information RII) with each other through a peer-to-peer (P2P) communication network or various networking mechanisms.

The blockchain network 150 is a technical infrastructure that provides a blockchain ledger and smart contract (or chaincode) services to applications (e.g., the sender's e-wallet 115 and the receiver's e-wallet 135). The blockchain network 150 may process a blockchain ledger or a distributed ledger.

The blockchain network 150 includes a plurality of blockchain nodes 151, 153, and 155. At least one of the blockchain nodes 151, 153, and 155 receives (or picks up) the remittance information (including SADD, RADD, TA, STS, and PuK) from the sender's e-wallet 115, generates a next block (or a new block) NB next to a current block CB, and stores the remittance information (including SADD, RADD, TA, STS, and PuK) in the next block NB in operation S150.

For example, the sender's e-wallet 115 or each of the blockchain nodes 151, 153, and 155 may generate the remittance information (including SADD, RADD, TA, STS, and PuK) or a transaction including the remittance information (including SADD, RADD, TA, STS, and PuK), and store (in a blockchain manner) the remittance information (including SADD, RADD, TA, STS, and PuK) or transaction the in the blockchain network 150 or the next block NB of each of the blockchain nodes 151, 153, and 155.

When the remittance information (including SADD, RADD, TA, STS, and PuK) is stored in the next block NB of at least one of the blockchain nodes 151, 153, and 155, the sender's e-wallet 115, which monitors the storage of the remittance information, updates a sender token balance STB in operation S155.

The receiver's e-wallet 135 monitors an update, which is performed with respect to the next block NB of at least one of the blockchain nodes 151, 153, and 155 included in the blockchain network 150, or the addition of the remittance information (including SADD, RADD, TA, STS, and PuK) to the next block NB and reads the remittance information (including SADD, RADD, TA, STS, and PuK), which is transmitted to the receiver address RADD, according to a monitoring result in operation S160.

The receiver's e-wallet 135 receives the sender identity information SII, the blockchain information BCI, and the sender address SADD from the sender's e-wallet 115 through the state channel 170 in operation S170.

After operation S160 or S170 is performed, the receiver's e-wallet 135 transmits the receiver identity information RII, the blockchain information BCI, and the receiver address RADD to the state channel 170 in operation S172. The state channel 170 transmits the receiver identity information RII, the blockchain information BCI, and the receiver address RADD to the sender's e-wallet 115 in operation S174.

The sender's e-wallet 115 receives and displays the receiver identity information RII, the blockchain information BCI, and the receiver address RADD on a display in operation S176.

Because the receiver's e-wallet 135 may verify the digitally signed transaction STS by using the receiver's public key, the sender address SADD, the receiver address RADD, and the token amount TA, which are included in the transaction TS, are verified.

The receiver's e-wallet 135 updates a receiver token balance RTB based on the token amount TA and displays the sender identity information SII, the blockchain information BCI, and the sender address SADD on a display in operation S180.

In an operation method of the blockchain remittance service system 100, the sender's e-wallet 115 simultaneously accesses the blockchain network 150 and the state channel 170 and transmits digitally signed remittance information to the blockchain network 150 and simultaneously transmits the sender identity information SII to the receiver's e-wallet 135 through the state channel 170. The digitally signed remittance information is generated based on an address used to remit the token amount TA of the blockchain network 150 to the receiver's e-wallet 135.

For convenience of description, it is illustrated in FIG. 1 that the remittance information processed in operations S130, S150, and S160 includes SADD, RADD, TA, STS, and PuK. However, according to embodiments, the remittance information processed in operations S130, S150, and S160 may include only SADD, RADD, TA, and STS.

According to embodiments, the public key PuK may be used like the sender address SADD, and accordingly, a process of generating the sender address SADD may not be performed. When the public key PuK is used instead of the sender address SADD, the TS may include PuK, RADD, and TA in operation S120, and the remittance information processed in operations S130, S150, and S160 may include PuK, RADD, TA, and STS.

For convenience of description, it is illustrated in FIG. 1 that the sender information processed in operations S140, S170, and S180 includes SII, BCI, and SADD. However, according to embodiments, the sender information processed in operations S140, S170, and S180 may include SII and SADD.

Although it is illustrated in FIG. 1 that the receiver information processed in operations S172, S174, and S176 includes RII, BCI, and RADD, however the receiver information processed in operations S172, S174, and S176 may include RII and RADD.

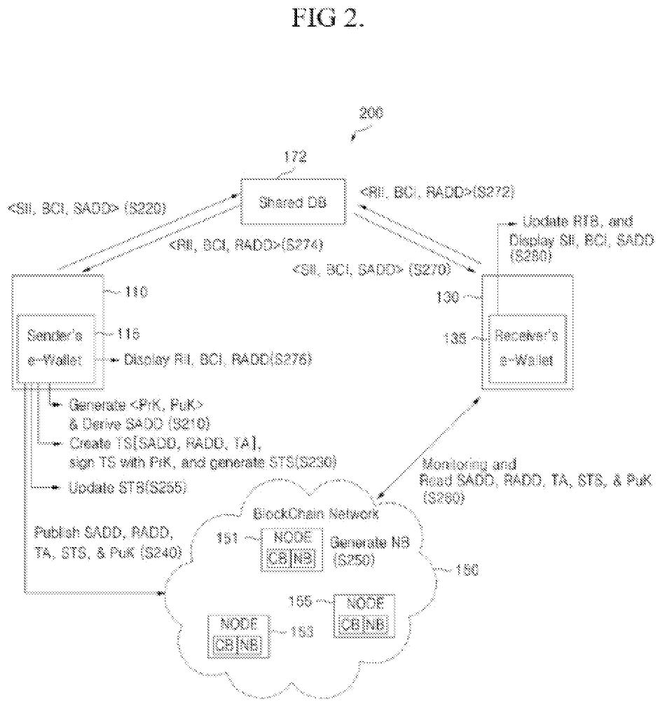

FIG. 2 is a block diagram of a blockchain remittance service system including a shared database (DB), according to an embodiment of the present disclosure. Referring to FIG. 2, a blockchain remittance service system (e.g., a blockchain system or a distributed ledger processing system) 200 includes a sender computing device 110, a receiver computing device 130, a shared DB 172, and a blockchain network 150.

The shared DB 172 is an example of an information transmission channel (or an information transmission device) that may transmit information described below in operations S220, S270, S272, and S274.

The sender's e-wallet 115 generates the pair <PrK, PuK> of the private key PrK of the sender and the public key PuK of the sender and generates (or derives) the sender address SADD from the public key PuK (or by applying a hash function to the public key PuK) in operation S210.

The sender's e-wallet 115 transmits a sender identity information SII which is related with the transaction TS, blockchain information BCI, and a sender address SADD to the shared DB 172 in operation S220.

When the sender inputs the receiver address RADD and the token amount TA corresponding to a remittance amount into the sender's e-wallet 115, the sender's e-wallet 115 creates the transaction TS, which includes the sender address SADD, the receiver address RADD, and the token amount TA, and generates the digitally signed transaction STS by digitally signing the transaction TS with the private key PrK in operation S230. The sender's e-wallet 115 generates remittance information (including SADD, RADD, TA, STS, and PuK) and publishes the remittance information on the blockchain network 150 in operation S240.

The blockchain network 150 includes the blockchain nodes 151, 153, and 155. Each of the blockchain nodes 151, 153, and 155 receives the remittance information (including SADD, RADD, TA, STS, and PuK) from the sender's e-wallet 115, generates the next block NB next to the current blocks CB, and stores the remittance information (including SADD, RADD, TA, STS, and PuK) in the next block NB in operation S250.

When the remittance information (including SADD, RADD, TA, STS, and PuK) is stored in the next block NB of at least one of the blockchain nodes 151, 153, and 155, the sender's e-wallet 115, which monitors the storage of the remittance information, updates the sender token balance STB in operation S255.

The receiver's e-wallet 135 monitors an update, which is performed with respect to the next block NB of at least one of the blockchain nodes 151, 153, and 155 included in the blockchain network 150, or the addition of the remittance information (including SADD, RADD, TA, STS, and PuK) to the next block NB and reads the remittance information (including SADD, RADD, TA, STS, and PuK), which is transmitted to the receiver address RADD, according to a monitoring result in operation S260.

Because the receiver's e-wallet 135 may verify the digitally signed transaction STS by using the receiver's public key, the sender address SADD, the receiver address RADD, and the token amount TA, which are included in the transaction TS, are verified.

The receiver's e-wallet 135 may retrieve the sender identity information SII, the blockchain information BCI, and the sender address SADD from the shared DB 172 by using the sender address SADD as a key in operation S270. According to embodiments, when a certain address is used across several blockchains, a pair <SADD, BCI> of the sender address SADD and the blockchain information BCI may be used as the key.

Before or after operation S260 is performed or after operation S170 is performed, the receiver's e-wallet 135 transmits the receiver identity information RII, the blockchain information BCI, and the receiver address RADD to the shared DB 172 in operation S272. The shared DB 172 transmits the receiver identity information RII, the blockchain information BCI, and the receiver address RADD to the sender's e-wallet 115 in operation S274.

For example, the sender's e-wallet 115 may search for the receiver identity information RII, the blockchain information BCI, and the receiver address RADD by using the receiver address RADD as a key. According to embodiments, when a certain address is used across several blockchains, a pair <RADD, BCI> of the receiver address RADD and the blockchain information BCI may be used as a key. When the probability of different users using the same address is very low, the sender address SADD or the receiver address RADD may be used as a key.

The sender's e-wallet 115 receives and displays the receiver identity information RII, the blockchain information BCI, and the receiver address RADD on a display in operation S276.

The receiver's e-wallet 135 updates the receiver token balance RTB based on the token amount TA and displays the sender identity information SII, the blockchain information BCI, and the sender address SADD on a display in operation S280.

For convenience of description, it is illustrated in FIG. 2 that the remittance information processed in operations S240, S250, and S260 includes the sender address SADD, the receiver address RADD, the token amount TA, the digitally signed transaction STS, and the public key PuK. However, according to embodiments, the remittance information processed in operations S240, S250, and S260 may include the sender address SADD, the receiver address RADD, the token amount TA, and the digitally signed transaction STS.

According to embodiments, the public key PuK may be used as the sender address SADD, and accordingly, a process of generating the sender address SADD may not be performed. When the public key PuK is used instead of the sender address SADD, the TS may include PuK, RADD, and TA in operation S220, and the remittance information processed in operations S240, S250, and S260 may include the public key PuK, the receiver address RADD, the token amount TA, and the digitally signed transaction STS.

For convenience of description, it is illustrated in FIG. 2 that the sender information processed in operations S220, S270, and S280 includes the sender identity information SII, the blockchain information BCI, and the sender address SADD. However, according to embodiments, the remittance information processed in operations S220, S270, and S280 may include the sender identity information SII and the sender address SADD.

Although it is illustrated in FIG. 2 that the receiver information processed in operations S272, S274, and S276 includes the receiver identity information RII, the blockchain information BCI, and the receiver address RADD, the receiver information processed in operations S272, S274, and S276 may include the receiver identity information RII and the receiver address RADD.

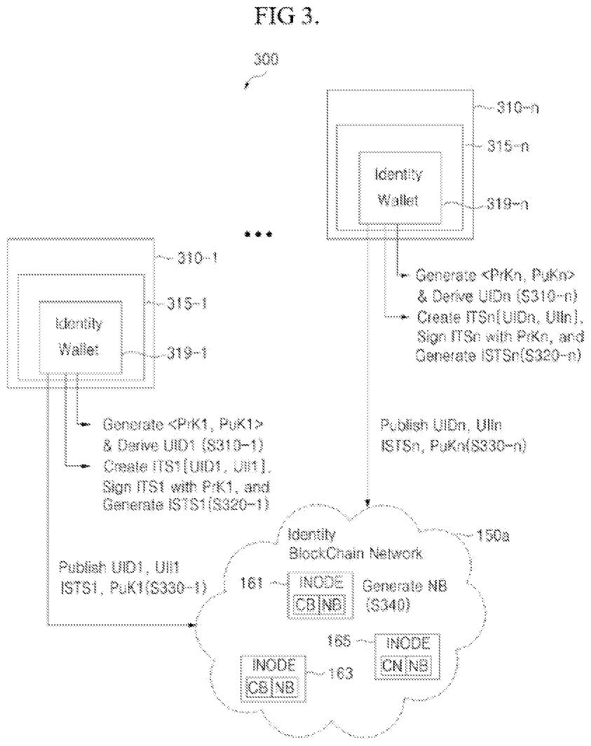

FIG. 3 is a diagram for describing the operations of each of identity wallets storing information in an identity blockchain network, according to an embodiment of the present disclosure. Referring to FIG. 3, an identity blockchain network 150a may be used in a blockchain remittance service system (e.g., a blockchain system or a distributed ledger processing system) 300. At this time, the blockchain remittance service system 300 includes a plurality of computing devices 310-1 to 310-n and the identity blockchain network 150a. Here, “n” is a natural number of at least 2)

The identity blockchain network 150a performs a function of an information transmission channel (or an information transmission device).

Each e-wallet 315-1 to 315-n executed by each processor (or CPU) of each computing device 310-1 to 310-n includes each identity wallet 319-1 to 319-n.

The first identity wallet 319-1 included in the first e-wallet 315-1 executed on the first computing device 310-1 generates a pair <PrK1, PuK1> of a first private key PrK1 and a first public key PuK1 of a user of the first computing device 310-1 and generates (or derives) a first user identification (ID) UID1 from the first public key PuK1 (or by applying a hash function to the first public key PuK1) in operation S310-1.

The first identity wallet 319-1 creates a first identity transaction ITS1, which includes the first user ID UID1 of the user of the first computing device 310-1 and first user identity information UII1 of the user of the first computing device 310-1, and generates a digitally signed first identity transaction ISTS1 by digitally signing the first identity transaction ITS1 with the first private key PrK1 in operation S320-1. The first identity wallet 319-1 generates and publishes first information (including UID1, UII1, ISTS1, and PuK1) on the identity blockchain network 150a in operation S330-1.

Here, the identity blockchain network 150a refers to a blockchain network that is different from the blockchain network 150 in FIGS. 1, 2, and 4 (for example, a blockchain network that is separate from the blockchain network 150 logically (or in terms of software) or physically (or in terms of hardware)).

The identity blockchain network 150a includes a plurality of identity blockchain nodes 161, 163, and 165. Each of the identity blockchain nodes 161, 163, and 165 receives the first information (including UID1, UII1, ISTS1, and PuK1) from the first identity wallet 319-1, generates a next block NB next to current blocks CB, and stores the first information (including UID1, UII1, ISTS1, and PuK1) in the next block NB in operation S340.

The n-th identity wallet 319-n included in the n-th e-wallet 315-n executed on the n-th computing device 310-n generates a pair <PrKn, PuKn> of an n-th private key PrKn and an n-th public key PuKn of a user of the n-th computing device 310-n and generates (or derives) an n-th user ID UIDn from the n-th public key PuKn (or by applying a hash function to the n-th public key PuKn) in operation S310-n.

The n-th identity wallet 319-n creates an n-th identity transaction ITSn, which includes the n-th user ID UIDn of the user of the n-th computing device 310-n and n-th user identity information UIIn of the user of the n-th computing device 310-n, and generates a digitally signed n-th identity transaction ISTSn by digitally signing the n-th identity transaction ITSn with the n-th private key PrKn in operation S320-n. The n-th identity wallet 319-n generates and publishes n-th information (including UIDn, UIIn, ISTSn, and PuKn) on the identity blockchain network 150a in operation S330-n.

The identity blockchain network 150a includes the identity blockchain nodes 161, 163, and 165. Each of the identity blockchain nodes 161, 163, and 165 receives the n-th information (including UIDn, UIIn, ISTSn, and PuKn) from the n-th identity wallet 319-n, generates a next block NB next to current blocks CB, and stores the n-th information (including UIDn, UIIn, ISTSn, and PuKn) in the next block NB in operation S340. One or more next blocks are collectively named the next block NB.

For example, a user refers to a sender or a receiver, and user identity information may include information (e.g., a name, an address, and/or a date of birth) by which the user may be uniquely identified.

Each time when operations S330-1 to S330-n are performed by each of computing devices 310-1 to 310-n, each of the identity blockchain nodes 161, 163, and 165 may generate a next block (or a new block) and store information (e.g., UIDi, UIIi, ISTSi, and PuKi, where 1≤i≤n), which is transmitted from each of computing devices 310-1 to 310-n, in the next block.

For convenience of description, it is illustrated in FIG. 3 that information processed in operation S330-i (1≤i≤n) includes UIDi, UIIi, ISTSi, and PuKi. However, according to embodiments, the information processed in operation S330-i may include UIDi, UIIi, and ISTSi.

According to embodiments, because a public key PuKi may be used as a user ID UIDi, a process of generating the user ID UIDi may not be performed. Accordingly, ITSi processed in operation S320-i (1≤i≤n) may include PuKi and UIIi, and information processed in operation S330-i may include PuKi, UIIi, and ISTSi.

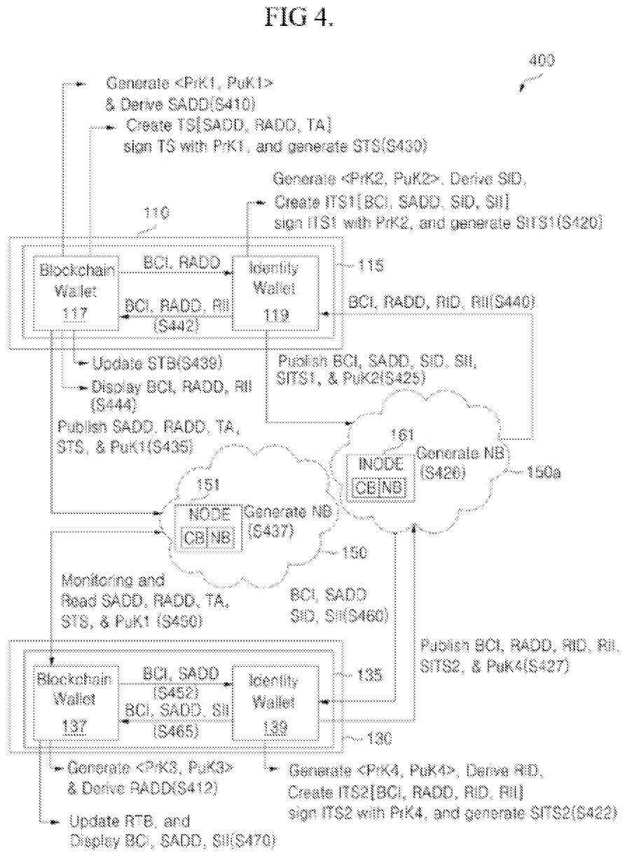

FIG. 4 is a block diagram of a blockchain remittance service system including an identity blockchain network, according to an embodiment of the present disclosure.

Referring to FIGS. 3 and 4, a blockchain remittance service system (e.g., a blockchain system or a distributed ledger processing system) 400 includes a sender computing device 110, a receiver computing device 130, a blockchain network 150, and an identity blockchain network 150a. The blockchain network 150 is different (for example, separate logically (or in terms of software) or physically (or in terms of hardware)) from the identity blockchain network 150a.

The identity blockchain network 150a is an example of an information transmission channel (or an information transmission device) that may transmit information described below in operations S425, S426, S427, S440, and S460.

The sender's e-wallet 115 includes a first blockchain wallet 117 and a first identity wallet 119, and the receiver's e-wallet 135 includes a second blockchain wallet 137 and a second identity wallet 139.

The first blockchain wallet 117 generates a pair <PrK1, PuK1> of a first private key PrK1 and a first public key PuK1 of a sender and generates (or derives) a sender address SADD from the first public key PuK1 (or by applying a hash function to the first public key PuK1) in operation S410. The blockchain information BCI and the receiver address RADD are transmitted from the first blockchain wallet 117 to a first identity wallet 119.

The second blockchain wallet 137 generates a pair <PrK3, PuK3> of a third private key PrK3 and a third public key PuK3 of a receiver and derives the receiver address RADD from the third public key PuK3 (or by applying a hash function to the third public key PuK3) in operation S412. The blockchain information BCI and the sender address SADD are transmitted from the second blockchain wallet 137 to the second identity wallet 139 in operation S452.

The first identity wallet 119 generates a pair <PrK2, PuK2> of a second private key PrK2 and a second public key PuK2 of the sender, generates a sender ID SID from the second public key PuK2 (or by applying a hash function to the second public key PuK2), creates the first identity transaction ITS1, which includes the blockchain information BCI, the sender address SADD, the sender ID SID, and the sender identity information SII, and generates a digitally signed first identity transaction SITS1 by digitally signing the first identity transaction ITS1 with the second private key PrK2 in operation S420. The first identity wallet 119 generates and publishes sender information (including BCI, SADD, SID, SII, SITS1, and PuK2) on the identity blockchain network 150a in operation S425.

According to embodiments, the first private key PrK1 and the second private key PrK2 may be the same as each other (PrK1=PrK2) or different from each other (PrK1≠PrK2). The first public key PuK1 and the second public key PuK2 may be the same as each other (PuK1=PuK2) or different from each other (PuK1≠PuK2).

The second identity wallet 139 generates a pair <PrK4, PuK4> of a fourth private key PrK4 and a fourth public key PuK4 of a receiver, generates a receiver ID RID from the fourth public key PuK4 (or by applying a hash function to the fourth public key PuK4), creates a second identity transaction ITS2, which includes blockchain information BCI, a receiver address RADD, the receiver ID RID, and a receiver identity information RII, and generates a digitally signed second identity transaction SITS2 by digitally signing the second identity transaction ITS2 with the fourth private key PrK4 in operation S422. The second identity wallet 139 generates and publishes receiver information (including BCI, RADD, RID, RII, SITS2, and PuK4) on the identity blockchain network 150a in operation S427.

According to embodiments, the third private key PrK3 and the fourth private key PrK4 may be the same as each other (PrK3=PrK4) or different from each other (PrK3≠PrK4). The third public key PuK3 and the fourth public key PuK4 may be the same as each other (PuK3=PuK4) or different from each other (PuK3≠PuK4).

The identity blockchain node 161 of an identity blockchain network 150a stores (or records) the sender information (including BCI, SADD, SID, SII, SITS1, and PuK2), which is received in operation S425, in a first next block and the receiver information (including BCI, RADD, RID, RII, SITS2, and PuK4), which is received in operation S427, in a second next block in operation S426. For convenience of description, the first and second next blocks are collectively named a next block NB in FIG. 4.

When the sender inputs a receiver address RADD and a token amount TA corresponding to a remittance amount into a first blockchain wallet 117, the first blockchain wallet 117 creates transaction TS including a sender address SADD, the receiver address RADD, and the token amount TA and generates a digitally signed transaction STS by digitally signing the transaction TS with a first private key PrK1 in operation S430. The first blockchain wallet 117 generates and publishes remittance information (including SADD, RADD, TA, STS, and PuK1) on the blockchain network 150 in operation S435.

The blockchain node 151 of a blockchain network 150 receives remittance information (including SADD, RADD, TA, STS, and PuK1) from a first blockchain wallet 117, generates a next block NB next to a current block CB, and stores the remittance information (including SADD, RADD, TA, STS, and PuK1) in the next block NB in operation S437.

When remittance information (including SADD, RADD, TA, STS, and PuK1) is stored in a next block NB of a blockchain node 151, the first blockchain wallet 117 updates a sender token balance STB in operation S439.

The first identity wallet 119 reads receiver information (e.g., blockchain information BCI, a receiver address RADD, a receiver ID RID, and a receiver identity information RII) from an identity blockchain network 150a by using, as a key, the receiver address RADD (or, according to embodiments, the receiver address RADD and the blockchain information BCI) transmitted from a first blockchain wallet 117 in operation S440. The first identity wallet 119 transmits blockchain information BCI, a receiver address RADD, and a receiver identity information RII to a first blockchain wallet 117 in operation S442.

The first blockchain wallet 117 receives and displays the blockchain information BCI, the receiver address RADD, and the receiver identity information RII on a display in operation S444.

According to embodiments, the blockchain information BCI and/or the receiver ID RID may or may not be necessary in operation S440. According to embodiments, the blockchain information BCI and the receiver address RADD may not be necessary in operation S442. In other words, according to embodiments, minimum information processed in operations S440, S442, and S444 is the receiver identity information RII.

The second blockchain wallet 137 monitors an update, which is performed with respect to the next block NB of the blockchain node 151 included in the blockchain network 150, or the addition of the remittance information (SADD, RADD, TA, STS, and PuK1) to the next block NB and reads the remittance information (SADD, RADD, TA, STS, and PuK1) according to a monitoring result in operation S450.

The second blockchain wallet 137 transmits the blockchain information BCI and the sender address SADD to the second identity wallet 139 in operation S452. The second identity wallet 139 reads the blockchain information BCI, the sender address SADD, the sender ID SID, and the sender identity information SII from the identity blockchain network 150a by using, as a key, the sender address SADD (or, according to embodiments, the sender address SADD and the blockchain information BCI) transmitted from the second blockchain wallet 137 in operation S460. The second identity wallet 139 transmits the blockchain information BCI, the sender address SADD, and the sender identity information SII to the second blockchain wallet 137 in operation S465.

The second blockchain wallet 137 updates the receiver token balance RTB based on the token amount TA and receives and displays the blockchain information BCI, the sender address SADD, and the sender identity information SII on a display in operation S470.

According to embodiments, the blockchain information BCI and/or the sender ID SID may or may not be necessary in operation S460. According to embodiments, the blockchain information BCI and the sender address SADD may not be necessary in operation S465. In other words, according to embodiments, minimum information processed in operations S460, S465, and S470 is the sender identity information SII.

According to embodiments, the first public key PuK1 may or may not be included in operations S435, S437, and S450. According to embodiments, the blockchain information BCI may or may not be included in operations S420, S422, S425, S426, S440, S442, S444, S452, S460, S465, and S470.

According to embodiments, the second public key PuK2 may or may not be included in operations S425 and S426, and the fourth public key PuK4 may or may not be included in operations S426 and S427.

According to embodiments, the blockchain information BCI may or may not be included in information transmitted from the first blockchain wallet 117 to the first identity wallet 119. According to embodiments, the blockchain information BCI may or may not be included in information transmitted from the second blockchain wallet 137 to the second identity wallet 139.

According to embodiments, the first public key PuK1 and the third public key PuK3 may be respectively used as the sender address SADD and the receiver address RADD, and therefore, a process of generating the sender address SADD and a process of generating the receiver address RADD may not be performed. When the first public key PuK1 is used instead of the sender address SADD, the transaction TS may include the first public key PuK1, the receiver address RADD, and the token amount TA in operation S430, and information processed in operations S435, S437, and S450 may include the first public key PuK1, the receiver address RADD, the token amount TA, and the digitally signed transaction STS.

In an operation method of the blockchain remittance service system 400, the sender's e-wallet 115 may simultaneously access the blockchain network 150 and the identity blockchain network 150a and transmits digitally signed remittance information to the blockchain network 150 and simultaneously transmits the sender identity information SII to the receiver's e-wallet 135 through the identity blockchain network 150a. The digitally signed remittance information is generated based on an address when the token amount TA of the blockchain network 150 is sent to the receiver's e-wallet 135.

Referring to FIGS. 1 and 2, the sender's e-wallet 115 stored in a medium (e.g., the processor of the sender computing device 110 or a data storage medium (e.g., a memory device) accessible by the processor of the sender computing device 110), which processes remittance information, sender information, and receiver information in combination with hardware (e.g., the sender computing device 110), operates as follows.

The sender's e-wallet 115 stores remittance information (e.g., the information described in operation S130 or S240) to be transmitted to the receiver's e-wallet 135 in the blockchain network 150 (or a distributed ledger processing network) in a blockchain manner (e.g., in a manner defined by the blockchain network 150 or by using distributed ledger processing), transmits sender information (e.g., the information described in operation S140 or S220) to be transmitted to the receiver's e-wallet 135 to an information transmission channel, e.g., the state channel 170 or the shared DB 172, and receives receiver information (e.g., the information described in operation S172 or S272) from the receiver's e-wallet 135 through the information transmission channel, e.g., the state channel 170 or the shared DB 172.

Referring to FIGS. 3 and 4, the sender's e-wallet 115 stored in a medium (e.g., the processor of the sender computing device 110 or a data storage medium (e.g., a memory device) accessible by the processor of the sender computing device 110), which processes remittance information, sender information, and receiver information in combination with hardware (e.g., the sender computing device 110), operates as follows.

The first identity wallet 119 of the sender's e-wallet 115 stores sender information (e.g., the information described in operation S425) to be transmitted to the second identity wallet 139 of the receiver's e-wallet 135 in the identity blockchain network 150a in a first blockchain manner (e.g., in a manner defined by the identity blockchain network 150a or by using first distributed ledger processing). The first blockchain wallet 117 (or a first distributed ledger processing network) of the sender's e-wallet 115 stores remittance information (e.g., the information described in operation S435) to be transmitted to the second blockchain wallet 137 of the receiver's e-wallet 135 in a second blockchain network or a second distributed ledger processing network in a second blockchain manner (e.g., in a manner defined by the blockchain network 150 or by using second distributed ledger processing). The first identity wallet 119 retrieves receiver information (e.g., the information described in operation S427) from the identity blockchain network 150a and transmits the receiver information (e.g., BCI, RADD, and RII) to the first blockchain wallet 117.

As described above with reference to FIGS. 1 and 2, according to various embodiments, TS may include: (1) SADD, RADD, and TA; or (2) PuK, RADD, and TA. The remittance information may include: (1) SADD, RADD, TA, STS, and PuK; (2) SADD, RADD, TA, and STS; or (3) PuK, RADD, TA, and STS. The sender information may include: (1) SII, BCI, and SADD; or (2) SII and SADD. The receiver information may include: (1) RII, BCI, and RADD; or (2) RII and RADD.

As described above with reference to FIG. 3, according to embodiments, ITS1 may include: (1) UID1 and UII1; or (2) PuK1 and UII1, and ITSn may include: (1) UIDn and UIIn; or (2) PuKn and UIIn. The first remittance information may include: (1) UID1, UII1, ISTS1, and PuK1; (2) UID1, UII1, and ISTS1; or (3) PuK1, UII1, and ISTS1. The n-th remittance information may include: (1) UIDn, UIIn, ISTSn, and PuKn; (2) UIDn, UIIn, and ISTSn; or (3) PuKn, UIIn, and ISTSn.

As described above with reference to FIG. 4, various embodiments, in which addition, exclusion, and replacement may be made in information processed in each of operations S410, S412, S420, S422, S425, S426, S427, S430, S435, S437, S440, S442, S444, S450, S452, S460, S465, and S470.

While this present disclosure has been described with reference to embodiments shown in the drawings, it will be understood by those of ordinary skill in the art that various changes in form and details may be made therein. Therefore, the scope of the present disclosure will be defined by the technical ideas of the appended claims.

### INDUSTRIAL APPLICABILITY

The present disclosure may be used for a blockchain remittance service system, an operation method of the blockchain remittance service system, and an electronic wallet for remittance.

1. An operation method of a blockchain remittance service system, the operation method comprising:
storing, performed by a sender's electronic wallet, remittance information in a blockchain network, the sender's electronic wallet being executed on a sender computing device; and
transmitting, performed by the sender's electronic wallet, sender information to an information transmission channel to allow a receiver's electronic wallet to acquire the sender information, the receiver's electronic wallet being executed on a receiver computing device.

2. The operation method of claim 1, wherein the remittance information includes a sender address, a receiver address, and a token amount corresponding to a remittance amount, and a digitally signed transaction,
the sender information includes sender identity information and the sender address, and
the sender's electronic wallet generates the digitally signed transaction by signing a transaction with a private key of the sender, the transaction including the sender address, the receiver address, and the token amount.

3. The operation method of claim 1, wherein the remittance information includes a public key of the sender, a receiver address, and a token amount corresponding to a remittance amount, and a digitally signed transaction,
the sender information includes sender identity information and a sender address, and
the sender's electronic wallet generates the digitally signed transaction by signing a transaction with a private key of the sender, the transaction including the public key, the receiver address, and the token amount.

4. The operation method of claim 1, further comprising:
receiving, performed by the sender's electronic wallet, receiver information from the information transmission channel; and
displaying, performed by the sender's electronic wallet, the receiver information on a display of the sender computing device,
wherein the receiver information includes receiver identity information and a receiver address.

5. The operation method of claim 1, further comprising:
receiving, performed by the receiver's electronic wallet, the sender information from the information transmission channel; and
displaying, performed by the receiver's electronic wallet, the sender information on a display of the receiver computing device,
wherein the sender information includes sender identity information and a sender address.

6. The operation method of claim 1, further comprising:
transmitting, performed by the receiver's electronic wallet, receiver information to the information transmission channel after the receiver's electronic wallet receives the sender information from the information transmission channel; and
receiving and displaying, performed by the sender's electronic wallet, the receiver information from the information transmission channel on a display of the sender computing device,
wherein the sender information includes sender identity information and a sender address, and
the receiver information includes receiver identity information and a receiver address.

7. The operation method of claim 1, further comprising:
reading, performed by the receiver's electronic wallet, the remittance information from the blockchain network;
transmitting, performed by the receiver's electronic wallet, receiver information to the information transmission channel; and
receiving and displaying, performed by the sender's electronic wallet, the receiver information from the information transmission channel on a display of the sender computing device,
wherein the sender information includes sender identity information and a sender address, and
the receiver information includes receiver identity information and a receiver address.

8. The operation method of claim 1, wherein the information transmission channel is a shared database.

9. The operation method of claim 1, wherein the information transmission channel is an identity blockchain network separate from the blockchain network.

10. The operation method of claim 9, further comprising transmitting, performed by the receiver's electronic wallet, receiver information to the identity blockchain network to allow the sender's electronic wallet to acquire the receiver information,
wherein the sender information includes sender identity information, and
the receiver information includes receiver identity information.

11. An electronic wallet program stored in a medium, which processes remittance information, sender information, and receiver information in combination with hardware, the electronic wallet program being configured to:
store remittance information to be transmitted to a receiver's electronic wallet program in a blockchain network;
transmit the sender information to be transmitted to the receiver's electronic wallet program to an information transmission channel; and
receive the receiver information from the receiver's electronic wallet program through the information transmission channel.

12. The electronic wallet program of claim 11, wherein the remittance information includes a sender address, a receiver address, and a token amount corresponding to a remittance amount, and a transaction digitally signed with a private key of a sender,
the sender information includes sender identity information and the sender address, and
the receiver information includes receiver identity information and the receiver address.

13. The electronic wallet program of claim 12, wherein each of the sender information and the receiver information further includes information about the blockchain network.

14. The electronic wallet program of claim 11, wherein the information transmission channel is a communication channel, a shared database, or an identity blockchain network separate from the blockchain network.

15. An electronic wallet program stored in a medium, which processes remittance information, sender information, and receiver information in combination with hardware, the electronic wallet program comprising:
a first identity wallet storing the sender information in a first blockchain network, the sender information being transmitted to a second identity wallet of a receiver's electronic wallet program; and
a first blockchain wallet storing the remittance information in a second blockchain network, the remittance information being transmitted to a second blockchain wallet of the receiver's electronic wallet program,
wherein the first identity wallet is further transmitting the receiver information stored in the first blockchain network to the first blockchain wallet, and
the first blockchain wallet is further displaying the receiver information on a display device.

16. The electronic wallet program of claim 15, wherein the remittance information includes a sender address, a receiver address, and a token amount corresponding to a remittance amount, and a transaction digitally signed with a first private key of a sender,
the sender information includes a sender identification (ID), sender identity information, and an identity transaction digitally signed with a second private key of the sender, and
the receiver information includes receiver identity information.

17. The electronic wallet program of claim 16, wherein the sender address is a first public key of the sender.

18. An operation method of a blockchain remittance service system, the operation method comprising:
storing, performed by a first identity wallet, sender information in a first blockchain network, the first identity wallet being included in a sender's electronic wallet, and the sender information being transmitted to a second identity wallet of a receiver's electronic wallet;
storing, performed by a first blockchain wallet, remittance information in a second blockchain network, the first blockchain wallet being included in the sender's electronic wallet, and the remittance information being transmitted to a second blockchain wallet of the receiver's electronic wallet;
transmitting, performed by the first identity wallet, receiver information stored in the first blockchain network to the first blockchain wallet; and
displaying, performed by the first blockchain wallet, the receiver information on a display of a sender computing device configured to execute the sender's electronic wallet.

19. The operation method of the blockchain remittance service system of claim 18, further comprising storing, performed by the second identity wallet, the receiver information in the first blockchain network.

20. The operation method of the blockchain remittance service system of claim 18, further comprising:
receiving and transmitting, performed by the second identity wallet, the sender information from the first blockchain network to the second blockchain network; and
displaying, performed by the second blockchain wallet, the sender information on a display of a receiver computing device configured to execute the receiver's electronic wallet.
